(19) United States
(12) Patent Application Publication
(10) Pub. No.: US 2008/0156078 A1
(43) Pub. Date: Jul. 3, 2008

(54) Method and device for measuring material properties

(75) Inventors: Wen-Hsin Hsieh, Chia-Yi (TW); Meng-Shiun Tsai, Chia-Yi (TW); Oscal Tzyh-Chiang Chen, Chia-Yi (TW); Song-Jeng Huang, Chia-Yi (TW); Tin-Kwang Lin, Chia-Yi (TW); Yu-Wen Huang, Chia-Yi (TW)

Correspondence Address: BACON & THOMAS, PLLC, 625 SLATERS LANE, FOURTH FLOOR, ALEXANDRIA, VA, 22314, US

(73) Assignees: NATIONAL CHUNG CHENG UNIVERSITY, CHIA-YI (TW); BUDDHIST DALIN TZU CHI GENERAL HOSPITAL, CHIA-YI (TW)

(21) Appl. No.: 11/902,376

(22) Filed: Sep. 21, 2007

(30) Foreign Application Priority Data
Jan. 3, 2007 (TW) 96100258

(51) Int. Cl. G01N 11/00; B06B 1/00; G01H 17/00

(52) U.S. Cl. 73/54.02; 422/127; 73/570

(57) ABSTRACT

A method of test includes the steps of preparing a sensing platform having an emitting electrode mounted at on one side thereof and a receiving electrode mounted on the other side thereof, wherein the sensing platform defines a sensing zone located between the emitting and receiving electrodes; placing a specimen on the sensing zone; emitting a surface acoustic wave from the emitting electrode, wherein the surface acoustic wave passes through the sensing zone and the specimen and then is received by the receiving electrode to be changed for its speed and phase by the change of material property of the specimen; and identifying the material property of the specimen according to the changed speed and phase of the surface acoustic wave to further infer the physical property of the specimen. In light of the steps, the surface acoustic wave can be employed for detection of the physical property of the specimen.

### BACKGROUND OF THE INVENTION

1. Field of the Invention

The present invention relates generally to the technology of detecting physical property, and more particularly, to a method of test and a device based on the method using surface acoustic wave.

2. Description of the Related Art

In monitoring the liver function, tests of Prothrombin Time (PT) and Activated Partial Thromboplastin Time (APTT) are the two primary items. If a patient has abnormal liver function resulting in reduction of coagulation factors produced therein, it will elongate the PT and thus the patient may not stop bleeding when injured. On the contrary, if the production of patient's coagulation factors is increased, it will shorten the PT to easily incur thrombus in the patient's body to further jeopardize the heath. For this reason, PT test is significant in monitoring the liver function.

The current method of PT test is scattered light test. First step is to irradiate a test tube containing a specimen therein with the light. When the blood is coagulated, the fibrin of the specimen increases to stop the light from moving forward and then the scattered light is generated. Next, a photosensitive element senses the change of the light at a given angle and then the time of blood coagulation is detected. The level of the scattered light intensity before coagulation has started is defined as 0%, and the level of the scattered light intensity is defined 100% after the coagulation is completed. In light of this, the coagulation detection point can be set 50%.

The current instrument based on scattered light test includes the automated blood coagulation analyzer, such as Sysmex-1500. Such instrument is user-friendly and is capable of measurement of numerous specimens at one time. However, such instrument is expensive and is slow in test to fail to do rapid test on site during office hours. In addition, such instrument is large and fails to be applied to the “point-of-care” or “disposable” test.

### SUMMARY OF THE INVENTION

The primary objective of the present invention is to provide a method of test and a device based on the method, which employs surface acoustic wave for test to be low-cost and small-sized.

The secondary objective of the present invention is to provide a method of test and a device based on the method, which can be applied to the point-of-care or disposable test.

The foregoing objectives of the present invention are attained by the method and the device. The method includes the steps of preparing a sensing platform having an emitting electrode mounted at on one side thereof and a receiving electrode mounted on the other side thereof, wherein the sensing platform defines a sensing zone located between the emitting and receiving electrodes; placing a specimen on the sensing zone; emitting a surface acoustic wave from the emitting electrode, wherein the surface acoustic wave passes through the sensing zone and the specimen and then is received by the receiving electrode to be changed for its speed and phase by the change of material property of the specimen; and identifying the material property of the specimen according to the changed speed and phase of the surface acoustic wave to further infer the physical property of the specimen.

The device is composed of a piezoelectric substrate, an oscillation circuit, and a sensing circuit. The piezoelectric substrate defines a sensing zone thereon, and an emitting electrode and a receiving electrode located at two sides of the sensing zone respectively. The oscillation circuit is electrically connected with the emitting and receiving electrodes. The sensing circuit is electrically connected with the oscillation circuit for detection of input and output frequency and/or phase from the oscillation circuit. In light of this, a surface acoustic wave can be generated on the piezoelectric substrate for the test of the above-mentioned method.

### BRIEF DESCRIPTION OF TILE DRAWINGS

FIG. 1 is a schematic view of a preferred embodiment of the present invention.

FIG. 2 is a schematic view of the preferred embodiment of the present invention in operation, illustrating that the specimen is dripped to the sensing zone.

FIG. 3 is another view of the first preferred embodiment of the present invention in operation, illustrating the condition that the surface acoustic wave passes through the sensing zone.

FIG. 4 is a block diagram of the preferred embodiment of the present invention.

### DETAILED DESCRIPTION OF PREFERRED EMBODIMENTS

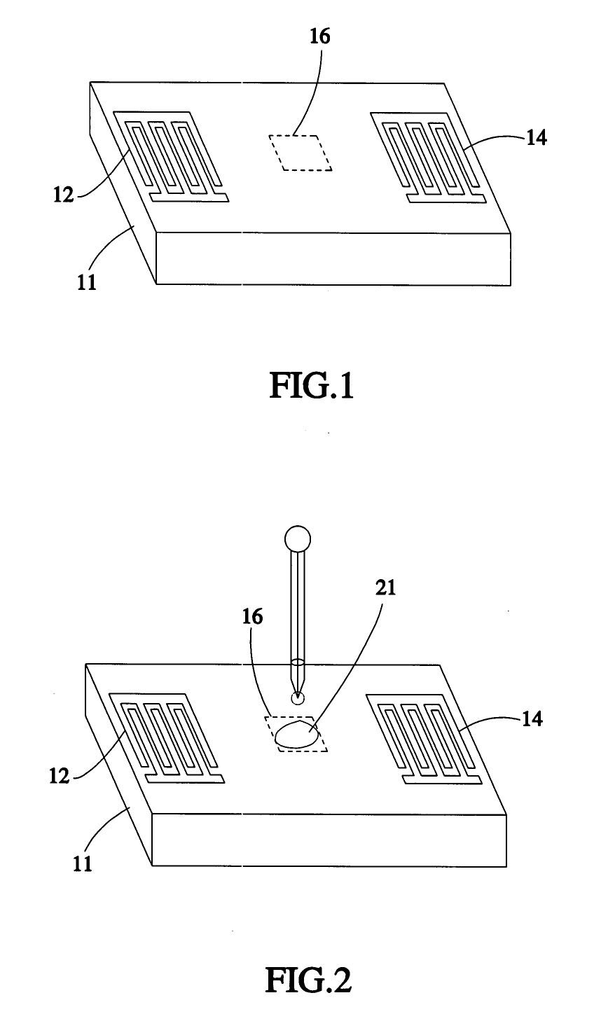

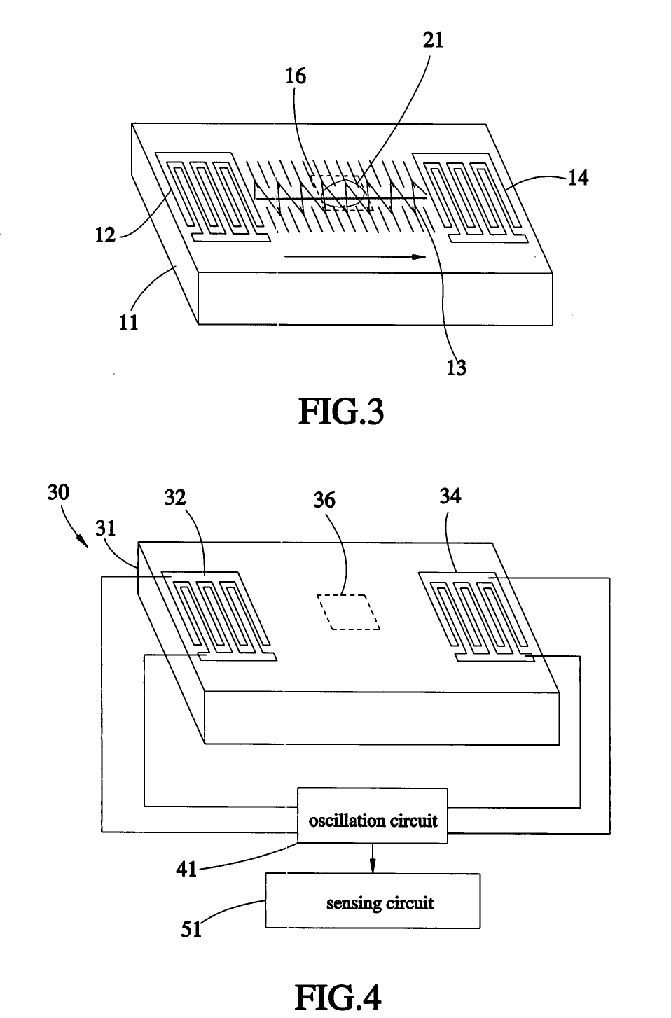

Referring to FIGS. 1-3, a method of test in accordance with a preferred embodiment of the present invention includes the following steps.

A. Prepare a sensing platform 11 which is a piezoelectric substrate in the embodiment. The sensing platform includes an emitting electrode 12 located at one side thereof, a receiving electrode 14 located at the other side thereof, and a sensing zone 16 defined between the emitting and receiving electrodes 12 and 14. Each of the emitting and receiving electrodes 12 and 14 is an interdigital transducer (IDT).

B. Place a specimen 21 on the sensing zone 16. In the embodiment, the specimen 21 is a mixture of the serum prepared sample (not shown) and blood coagulation reagent (not shown).

C. Emit a surface acoustic wave 13 from the emitting electrode 12 through the sensing zone 16 and the specimen 21 to the receiving electrode 14. When the surface acoustic wave 13 passes through the sensing zone 16, its speed and phase are changed subject to the material property of the specimen 21, wherein the material property of the specimen 21 is viscosity of the serum prepared sample.

D. Identify the material property of the specimen according to the changed speed and/or phase of the surface acoustic wave 13 to further infer the physical property of the specimen 21. In the embodiment, the physical property of the specimen is the viscosity of the serum prepared sample.

In light of the above-mentioned steps, keeping sensing the change of the speed and/or phase of the surface acoustic wave 13 passing through the mixture 21 can detect the coagulation time of the serum prepared sample to further infer the PT of the serum prepared sample. When the method is applied to the test of the patient's blood, it can detect the PT of the patient's blood for the purpose of the liver function test or for reference of other tests. Although the specimen 21 is the mixture of the serum prepared sample and the coagulation reagent in the embodiment, it does not limit the scope of the claim of the present invention and an alternative material or mixture can also be the specimen or everything based on the method defined in the claim of the present invention for test should also fall within the scope of the claim of the present invention.

Referring to FIG. 4, a sensing device 30 based on the above-mentioned method, constructed according to the preferred embodiment of the present invention, is composed of a piezoelectric substrate 31, an oscillation circuit 41, and a sensing circuit 51.

The piezoelectric substrate 31 defines a sensing zone 36 thereon, an emitting electrode 32 located at one side of the sensing zone 36, and a receiving electrode 34 located at the other side of the sensing zone 36.

The oscillation circuit 41 is electrically connected with the emitting and receiving electrodes 32 and 34.

The sensing circuit 51 is electrically connected with the oscillation circuit 41 for detection of output and input frequency and/or phase from the oscillation circuit 41.

The sensing device 30 is based on the method of the present invention for placing the specimen, i.e. the mixture of the serum prepared sample and the coagulation reagent, on the sensing zone 36, emitting the surface acoustic wave via the oscillation circuit 41 from the emitting electrode 32 toward the sensing zone 36, receiving the surface acoustic wave passing through the sensing zone 36 by the receiving electrode 34, sending it back to the oscillation circuit 41, and then detecting the input and output frequency and/or phase of the oscillation circuit 41 via the sensing circuit 51, finally inferring the physical property of the specimen.

Known from the above, the present invention includes the following advantages.

1. Low Cost and Small Size

The piezoelectric substrate and the electrodes applied in the method of the present invention are low-cost and small-sized and thus high production cost can be avoided.

2. Applicable to Point-Of-Care or Disposable Test

Because the present invention is small in size and rapid in test, it is capable of point-of-care test. Further, the present invention is low-cost, such that it can be easily applied to the disposable test.

Although the present invention has been described with respect to a specific preferred embodiment thereof, it is no way limited to the details of the illustrated structures but changes and modifications may be made within the scope of the appended claims.

What is claimed is:

1. A method of test comprising steps of:
preparing a sensing platform having an emitting electrode, a receiving electrode, and a sensing zone, said emitting electrode being located at a side of said sensing platform, said receiving platform being located at the other side of said sensing platform, said sensing zone being defined between said emitting and receiving electrodes;
placing a specimen on said sensing zone;
emitting a surface acoustic wave from said emitting electrode through said sensing zone and said specimen to said receiving electrode, wherein while said surface acoustic wave passes through said sensing zone, its speed and/or phase are changed subject to a material property of said specimen; and
identify said material property of said specimen according to the changed speed and/or phase of said surface acoustic wave to further infer a physical property of said specimen.

2. The method as defined in claim 1, wherein said specimen is a mixture of a serum prepared sample and a coagulation reagent; said material property of said specimen is viscosity of the serum prepared sample; said physical property of said specimen is prothrombin time.

3. The method as defined in claim 1, wherein each of said emitting and receiving electrodes is an interdigital transducer.

4. The method as defined in claim 1, wherein said sensing platform is a piezoelectric substrate.

5. A device based on the method defined in claim 1, comprising:
a piezoelectric substrate defining a sensing zone thereon, an emitting electrode located at a side of said sensing zone, and a receiving electrode located at the other side of said sensing zone;
an oscillation circuit electrically connected with said emitting and receiving electrodes; and
a sensing circuit electrically connected with said oscillation circuit for detection of input and output frequency and/or phase of said oscillation circuit.
